(19) United States
(12) Patent Application Publication
(10) Pub. No.: US 2025/0189683 A1
(43) Pub. Date: Jun. 12, 2025

(54) RADIATION SENSITIVE FILMS HAVING HIGH RADIATION SENSITIVITIES

(71) Applicant: ISP INVESTMENTS LLC, Wilmington, DE (US)

(72) Inventors: David K. HOOD, Basking Ridge, NJ (US); Carlos E. CAICEDO-CARVAJAL, Kendall Park, NJ (US)

(73) Assignee: ISP INVESTMENTS LLC, Wilmington, DE (US)

(21) Appl. No.: 18/969,806

(22) Filed: Dec. 5, 2024

Related U.S. Application Data
(60) Provisional application No. 63/606,899, filed on Dec. 6, 2023.

(51) Int. Cl. G01T 1/06

(52) U.S. Cl. CPC G01T 1/06

(57) ABSTRACT

The invention provides radiation sensitive films, radiation dosage indicators comprising these films, processes for preparing these films, and methods of use of these films in several industrial and domestic applications that require exposure to radiation for certain benefits. The radiation sensitive films comprise a radiation sensitive composition typically in the form of a film which is overlaid by an uncolored and optically transparent layer for increasing the radiation sensitivity of the films.

### BACKGROUND

### Field of the Invention

The disclosed and/or claimed inventive concept(s) provide radiation sensitive films having high radiation sensitivities due to the presence of one or more uncolored and optically transparent layers on a radiation sensitive active layer.

### Description of Related Art

In facilities where radiation sources are used, for example, in hospitals where cancer patients receive radiation treatments or in blood banks where blood products are irradiated, various methods are used to quantitatively determine the radiation exposure. The methods practiced include the use of thermoluminescent dosimeters (TLD's), ionization-type radiation detectors, photographic film, and radiochromic materials. TLD's are inconvenient because they require a complicated and time-consuming read-out process. Ionization-type radiation detectors are awkward and unwieldy and require a complicated setup. Photographic film requires a time-consuming chemical processing procedure before read-out. In case of radiochromic materials, the calculation of the dose requires a complex sequence of steps.

Photochromic polyacetylenes responsive to radiation exposure have been disclosed in several U.S. patents, namely U.S. Pat. Nos. 4,066,676; 4,581,315; 3,501,302; 3,501,297; 3,501,303; 3,501,308; 3,772,028; 3,844,791, and 3,954,816. The recording of image or dosage information using these polyacetylene compounds has presented several problems and shortcomings including an inadequate degree of resolution, clarity, color instability of an imaged pattern. Other deficiencies include a relatively slow image development, and, in some cases, the impractical need to image at extremely low temperatures or at excessively high dosage levels.

A preferred radiation sensitive material in radiation dosimeters includes dispersions of crystalline 10,12-pentacosadiynoic acid (PCDA). Subjecting monomeric PCDA crystals to ionizing radiation results in progressive polymerization, the degree of polymerization increasing with radiation dose. The amount of polymerization (and hence, the radiation dose) can be determined by measuring either the optical density or the spectral absorption of the exposed dosimeter. However, it has been found that these parameters also vary with both the temperature of the device when measured as well as the thickness of PCDA dispersion. Maximum accuracy of dose measurement must account for the temperature and thickness effects.

Radiation dosimetry film provides a means for measuring radiation exposure at a point, but its principal utility is in obtaining a two-dimensional map of radiation exposure, i.e. radiation exposure at multiple points in a two-dimensional array. A typical user may measure an 8″×10″ size film at a spatial resolution of 75 dpi, generating a map of radiation doses at 450,000 points. Of course, other resolutions can be used to generate the radiation exposure map.

U.S. Pat. No. 5,637,876 discloses a radiation dosimeter, exemplarily for use in determining a level of radiation to which a patient is subjected during radiation treatment, which comprises a substrate provided with a layer of radiation sensitive material. The radiation sensitive material has an optical density which varies systematically in accordance with the degree of radiation exposure. The dosimeter may take the form of a card or a flexible substrate which is positionable on the patient or other irradiation subject and which is also positionable in, or slidable through a slot in, a dose reader which includes a reflection or transmission densitometer.

U.S. Pat. No. 7,482,601 discloses a radiation-sensitive material comprising a radiochromic self-developing film comprising a support layer, a radiation sensitive composition disposed on the support layer, and a measuring scale of known dimensions for measuring a dimension or a location on the radiation-sensitive material.

U.S. Pat. No. 9,268,029 discloses a method for measuring a two-dimensional distribution of ionizing radiation doses with high spatial resolution.

U.S. Pat. No. 11,619,749 discloses a dosimetry device for quantifying a dosage of radiation emitted from a radiation source comprising a radiation dose indicator comprising a radiation sensitive film prepared from polyacetylene, lithium, sodium, potassium or zinc salt of polyacetylene capable of measuring an amount of radiation emitted from a radiation source, an optical means configured to capture the color change produced by the dose indicator after the dose indicator is exposed to the amount of radiation, and a software configured to compare an optical density of the color change produced by the dose indicator with a predetermined calibration curve to quantify the dosage of radiation emitted from the radiation source.

It has been found that radiation sensitive films and radiation dosimeters comprising these films according to the disclosed and/or claimed inventive concept(s) (a) have superior properties such as high radiation sensitivities and (b) are amenable for usage in several domestic, industrial, and healthcare applications that require radiation exposure for certain benefits.

### SUMMARY

In a first aspect, the disclosed and/or claimed inventive concept(s) provides a radiation sensitive film comprising (a) at least one first layer comprising a radiation sensitive composition capable of changing opacity in response to exposure to a radiation dosage exceeding a predetermined threshold; (b) on top or bottom of the first layer, at least one uncolored and optically transparent second layer; and (c) optionally, a protective layer on top of the second layer.

In a second aspect, the disclosed and/or claimed inventive concept(s) provides a process for preparing a radiation sensitive film comprising: (a) selecting at least one first layer in the form of a film of a radiation sensitive composition capable of changing opacity in response to exposure to a radiation dosage exceeding a predetermined threshold; (b) coating on top or bottom of the first layer, at least one uncolored and optically transparent second layer; and (c) optionally providing a protective layer on top of the second layer.

In a third aspect, the disclosed and/or claimed inventive concept(s) provides a process for preparing a radiation sensitive film comprising: (a) selecting at least one first layer in the form of a film of a radiation sensitive composition capable of changing opacity in response to exposure to a radiation dosage exceeding a predetermined threshold; (b) printing on top or bottom of the first layer, at least one uncolored and optically transparent second layer; and (c) optionally providing a protective layer on top of the second layer.

In a fourth aspect, the disclosed and/or claimed inventive concept(s) provides a process for preparing a radiation sensitive film comprising: (a) selecting at least one first layer in the form of a film of a radiation sensitive composition capable of changing opacity in response to exposure to a radiation dosage exceeding a predetermined threshold; (b) laminating on top or bottom of the first layer, at least one uncolored and optically transparent second layer; and (c) optionally providing a protective layer on top of the second layer.

In a fifth aspect, the disclosed and/or claimed inventive concept(s) provides a multilayer radiation dosage indicator comprising (a) a base substrate comprising a visible mark; (b) on top of the base substrate, at least one first layer comprising a radiation sensitive composition capable of changing opacity in response to exposure to a radiation dosage exceeding a predetermined threshold; (c) on top or bottom of the first layer, at least one uncolored and optically transparent second layer comprising a viewing zone through which the visible mark on the base substrate is viewable depending on opacity of the first layer prior to exposure to the radiation; and (d) optionally, a protective layer on top of the second layer.

### BRIEF DESCRIPTION OF THE DRAWINGS

The foregoing will be apparent from the following more particular description of exemplary, non-limiting embodiments of the disclosed and/or claimed inventive concept(s), as illustrated in the accompanying drawings. The drawings are not necessarily to scale, but emphasis is placed upon illustrating embodiments of the disclosed and/or claimed inventive concept(s).

FIG. 1 is a chart of Net Red Optical Density (Y axis) versus radiation dosage in gray units (Gy, X axis) of a radiation sensitive film according the disclosed and/or claimed inventive concept(s) and a comparative radiation sensitive film.

### DETAILED DESCRIPTION

Before explaining at least one aspect of the disclosed and/or claimed inventive concept(s) in detail, it is to be understood that the disclosed and/or claimed inventive concept(s) is not limited in its application to the details of construction and the arrangement of the components or steps or methodologies set forth in the following description or illustrated in the drawings. The disclosed and/or claimed inventive concept(s) is capable of other aspects or of being practiced or carried out in various ways. Also, it is to be understood that the phraseology and terminology employed herein is for the purpose of description and should not be regarded as limiting.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications referenced in any portion of this application are herein expressly incorporated by reference in their entirety to the same extent as if each individual patent or publication was specifically and individually indicated to be incorporated by reference.

All articles and/or methods disclosed herein can be made and executed without undue experimentation based on the present disclosure. While the articles and methods of the disclosed and/or claimed inventive concept(s) have been described in terms of aspects, it will be apparent to those of ordinary skill in the art that variations may be applied to the articles and/or methods and in the steps or in the sequence of steps of the method described herein without departing from the concept, spirit and scope of the disclosed and/or claimed inventive concept(s). All such similar substitutes and modifications apparent to those skilled in the art are deemed to be within the spirit, scope, and concept of the disclosed and/or claimed inventive concept(s).

As utilized in accordance with the disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.”

Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B_{Xn}, B_{Xn+1}, or combinations thereof” is intended to include at least one of: A, B_{Xn}, B_{Xn+1}, AB_{Xn}, A B_{Xn+1}, B_{Xn}B_{Xn+1}, or AB_{Xn}B_{Xn+1} and, if order is important in a particular context, also B_{Xn}A, B_{Xn+1}A, B_{Xn+1}B_{Xn}, B_{Xn+1}B_{Xn}A, B_{Xn}B_{Xn+1}A, AB_{Xn+1}B_{Xn}, B_{Xn}AB_{Xn+1}, or B_{Xn+1}AB_{Xn}. Continuing with this example, expressly included are combinations that contain repeats of one or more item or term, such as B_{Xn}B_{Xn}, AAA, MB_{Xn}, B_{Xn}B_{Xn}B_{Xn+1}, AAAB_{Xn}B_{Xn+1}B_{Xn+1}B_{Xn+1}B_{Xn+1}, B_{Xn+1}B_{Xn}B_{Xn}AAA, B_{Xn+1}A B_{Xn}AB_{Xn}B_{Xn}, and so forth. The skilled artisan will understand that typically there is no limit on the number of items or terms in any combination, unless otherwise apparent from the context.

The term “each independently selected from the group consisting of” means when a group appears more than once in a structure, that group may be selected independently each time it appears.

The term “hydrocarbyl” includes straight-chain and branched-chain alkyl, alkenyl, alkynyl, cycloalkyl, cycloalkenyl, aryl groups, and combinations thereof with optional heteroatom(s). A hydrocarbyl group may be mono-, di- or polyvalent.

The term “alkyl” refers to a functionalized or unfunctionalized, monovalent, straight-chain, branched-chain, or cyclic C₁-C₆₀ hydrocarbyl group optionally having one or more heteroatoms. In one non-limiting embodiment, an alkyl is a C₁-C₄₅ hydrocarbyl group. In another non-limiting embodiment, an alkyl is a C_{1-C30} hydrocarbyl group. Non-limiting examples of alkyl include methyl, ethyl, n-propyl, isopropyl, n-butyl, isobutyl, tert-butyl, n-pentyl, isopentyl, n-hexyl, n-heptyl, n-octyl, 2-ethylhexyl, tert-octyl, iso-norbornyl, n-dodecyl, tert-dodecyl, n-tetradecyl, n-hexadecyl, n-octadecyl, n-eicosyl, cyclobutyl, cyclopentyl, cyclohexyl, and the like. The definition of “alkyl” also includes groups obtained by combinations of straight-chain, branched-chain and/or cyclic structures.

The term “aryl” refers to a functionalized or unfunctionalized, monovalent, aromatic hydrocarbyl group optionally having one or more heteroatoms. The definition of aryl includes carbocyclic and heterocyclic aromatic groups. Non-limiting examples of aryl groups include phenyl, naphthyl, indenyl, indanyl, azulenyl, fluorenyl, anthracenyl, furyl, thienyl, pyridyl, pyrrolyl, oxazolyl, thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, isoquinolinyl, cinnolinyl, phthalazinyl, quinazolinyl, quinoxalinyl, 1,8-naphthridinyl, pteridinyl, carbazolyl, acridinyl, phenazinyl, phenothiazinyl, phenoxyazinyl, pyrazolo[1,5-c]triazinyl, and the like.

The term “aralkyl” refers to an alkyl group comprising one or more aryl substituent(s) wherein “aryl” and “alkyl” are as defined above. Non-limiting examples of aralkyl groups include benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like.

The term “alkylene” refers to a functionalized or unfunctionalized, divalent, straight-chain, branched-chain, or cyclic C₁-C₄₀ hydrocarbyl group optionally having one or more heteroatoms. In one non-limiting embodiment, an alkylene is a C₁-C₃₀ group. In another non-limiting embodiment, an alkylene is a C₁-C₂₀ group. Non-limiting examples of alkylene groups include:

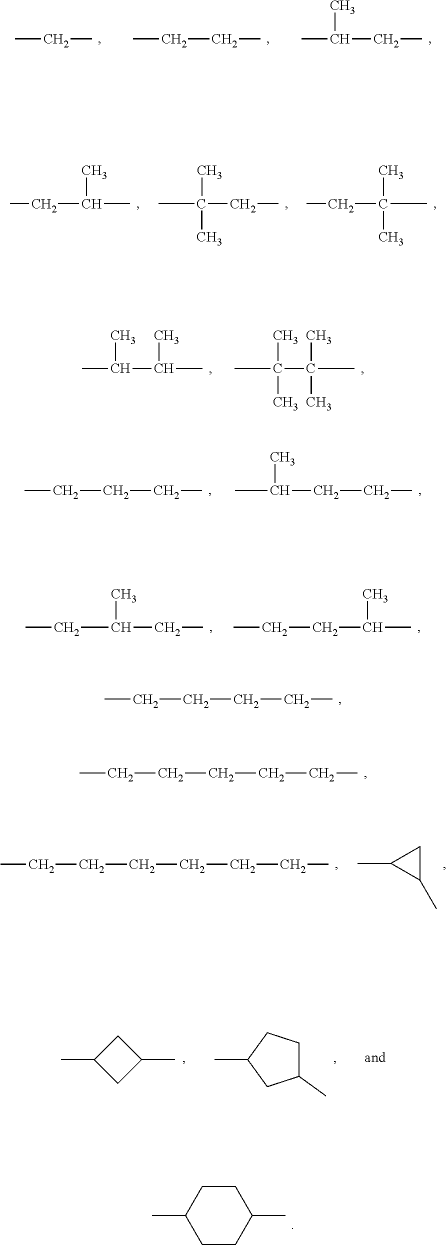

The term “arylene” refers to a functionalized or unfunctionalized, divalent, aromatic hydrocarbyl group optionally having one or more heteroatoms. The definition of arylene includes carbocyclic and heterocyclic groups. Non-limiting examples of arylene groups include phenylene, naphthylene, pyridinylene, and the like.

The term “heteroatom” refers to oxygen, nitrogen, sulfur, silicon, phosphorous, or halogen. The heteroatom(s) may be present as a part of one or more heteroatom-containing functional groups. Non-limiting examples of heteroatom-containing functional groups include ether, hydroxy, epoxy, carbonyl, carboxamide, carboxylic ester, carboxylic acid, imine, imide, amine, sulfonic, sulfonamide, phosphonic, and silane groups. The heteroatom(s) may also be present as a part of a ring such as in heteroaryl and heteroarylene groups.

The term “halogen” or “halo” refers to Cl, Br, I, or F.

The term “ammonium” includes protonated NH₃ as well as protonated primary, secondary, and tertiary organic amines.

The term “functionalized” with reference to any moiety refers to the presence of one or more “functional groups” in the moiety. Various functional groups may be introduced in a moiety by way of one or more functionalization reactions known to a person having ordinary skill in the art. Non-limiting examples of functionalization reactions include: alkylation, epoxidation, sulfonation, hydrolysis, amidation, esterification, hydroxylation, dihydroxylation, amination, ammonolysis, acylation, nitration, oxidation, dehydration, elimination, hydration, dehydrogenation, hydrogenation, acetalization, halogenation, dehydrohalogenation, Michael addition, aldol condensation, Canizzaro reaction, Mannich reaction, Clasien condensation, Suzuki coupling, carboxylation, sulfonation, carboxylic acid salt formation, sulfonic acid salt formation, and the like. The term “unfunctionalized” with reference to any moiety refers to the absence of functional groups in the moiety.

The term “monomer” refers to a small molecule that chemically bonds during polymerization to one or more monomers of the same or different kind to form a polymer.

The term “polymer” refers to a large molecule comprising one or more types of monomer residues (repeating units) connected by covalent chemical bonds. By this definition, polymer encompasses compounds wherein the number of monomer units may range from very few, which more commonly may be called as oligomers, to very many. Non-limiting examples of polymers include homopolymers, and non-homopolymers such as copolymers, terpolymers, tetra-polymers and the higher analogues. The polymer may have a random, block, and/or alternating architecture. The polymers may be nonionic, or may be cationic, anionic, or amphoteric in nature.

The term “homopolymer” refers to a polymer that consists essentially of a single monomer type.

The term “non-homopolymer” refers to a polymer that comprises more than one monomer types.

The term “copolymer” refers to a non-homopolymer that comprises two different monomer types.

The term “terpolymer” refers to a non-homopolymer that comprises three different monomer types.

The term “branched” refers to any non-linear molecular structure. The term includes both branched and hyper-branched structures.

The term “radiation sensitive” refers to the condition of exhibiting an alteration in one or more intrinsic or extrinsic properties in response to an incident radiation.

The term “metal” refers to a material that, when freshly prepared, polished, or fractured, typically shows a lustrous appearance, and is a good conductor of electricity and heat. This definition of a metal includes the several scientifically accepted categories of metals such as alkali metals, alkaline earth metals, lanthanoids, actinoids, transition metals, and post-transition metals.

The term “alkali metal” refers to metal elements lithium, sodium, potassium, rubidium, cesium, and francium.

The term “alkaline earth metal” refers to metal elements beryllium, magnesium, calcium, strontium, barium, and radium.

The term “coating composition” refers to a composition in the form of, for example, a solution, an emulsion, a suspension, or a dispersion, that is suitable for applying onto a surface of a substrate.

The term “substrate” refers to a material that serves as a base for a composition such as a coating composition.

The term “device” refers to a fabricated material.

The term “discontinuous coating” refers to a coating that unlike a film does not provide a complete coverage of the surface of a substrate on which the coating is applied. Particular, yet non-limiting examples of discontinuous coatings include those obtained from printing processes such as inkjet printing, dot matrix printing, layer printing, pad printing and the like.

The term “Net Red Optical Density” refers to the relative measure of the optical density value of a film exposed to a red channel of radiation compared to that of the unexposed film based on Beer Lambert laws.

The term “optically transparent” means that a sufficient amount of light within the wavelength range of operation can pass through for the particular application.

All percentages, ratio, and proportions used herein are based on a weight basis unless other specified.

In a first aspect, the disclosed and/or claimed inventive concept(s) provides a radiation sensitive film comprising (a) at least one first layer comprising a radiation sensitive composition capable of changing opacity in response to exposure to a radiation dosage exceeding a predetermined threshold; (b) on top or bottom of the first layer, at least one uncolored and optically transparent second layer; and (c) optionally, a protective layer on top of the second layer.

In one non-limiting embodiment, the first layer is white. In another non-limiting embodiment, the first layer is not colored.

In one non-limiting embodiment, the bottom surface of the second layer of the radiation sensitive film according to the disclosed and/or claimed inventive concept(s) comprises an uncolored and optically transparent adhesive layer for attaching the first layer to the second layer.

In one non-limiting embodiment, the radiation sensitive composition comprises at least one acetylenic compound.

In one non-limiting embodiment, the acetylenic compound comprises at least one acetylene moiety and at least one non-acetylenic functional group.

In one non-limiting embodiment, the non-acetylenic functional group is selected from the group consisting of carboxyl, carboxylate, hydroxy, hydroxide, alkoxy, alkoxide, epoxy, amino, ammonium, aldehyde, keto, amide, ester, nitrile, urethane, ether, and combinations thereof. In one particular non-limiting embodiment, the non-acetylenic functional group is selected from the group consisting of carboxyl, carboxylate, and combinations thereof.

In one non-limiting embodiment, the acetylenic compound is selected from the group consisting of decadiynoic acids, undecadiynoic acids, dodecadiynoic acids, tridecadiynoic acids, tetradecadiynoic acids, pentadecadiynoic acids, hexadecadiynoic acids, heptadecadiynoic acids, octadecadiynoic acids, nonadecadiynoic acids, icosadiynoic acids, heneicosadiynoic acids, docosadiynoic acids, tricosadiynoic acids, tetracosadiynoic acids, pentacosadiynoic acids, hexacosadiynoic acids, heptacosadiynoic acids, octacosadiynoic acids, nonacosadiynoic acids, triacontanediynoic acids, salts thereof, and combinations thereof.

In one non-limiting embodiment, the acetylenic compound is selected from the group consisting of 10,12-pentacosadiynoic acid, a salt thereof, and combinations thereof.

Additional insight into the properties, functionality and application(s) of radiation sensitive acetylene compounds is disclosed in Hall et al. in Chemical Science, 2020, volume 11, 8025-8035, the disclosure of which is herein incorporated by reference in its entirety.

In one non-limiting embodiment, the radiation sensitive composition comprises at least one radiation sensitive dye.

In one non-limiting embodiment, the radiation sensitive dye is selected from the group consisting of spiropyrans, spirothiopyrans, spironapthooxazines, spirobenzopyrans, spiroindolobenzopyrans, chromenes, 2,2-dichlorchromenes, leuco quinines, anthroquinone dyes, thiazine leuco dyes, oxazine leuco dyes, phenazine leuco dyes, monoarylmethane phthalides, diarylmethane phthalides, triarylmethane phthalides, monoheterocyclic phthalides, bisheterocyclic phthalides, alkenylphthalides, bridged phthalides, bisphthalides, diarylmethanes, triarylmethanes, triarylmethane lactones, fluoran leuco dyes, tetrazolium salts, diazo dyes, nitro dyes, phthalein dyes, triphenylmethane dyes, benzeins, indophenols, quinolines, anthraquinones, indigo dyes, indamines, thiazines, pH-sensitive dyes, and UV-oxidizable dyes.

Non-limiting, yet particular examples of radiation sensitive dyes include diphenyl iodonium (DPI) chloride, DPI-hexafluorophosphate, DPI-perfluor-1-butanesulfonate, DPI-triflate, 4-iodophenyl diphenyl sulfonium triflate, 4-methylthiophenyl diphenyl sulfonium triflate, 2-napthyl diphenyl sulfonium triflate, 4-chlorophenyl diphenyl sulfonium triflate, and 4-bromophenyl diphenyl sulfonium triflate, thymol blue, malachite green, bromocresol green, indophenol blue, hydroxyethyl amino-azobenzene, methyl red, phenol red, ethyl orange, m-Cresol purple, New Fuchsin, p-methyl red, lissamine green, aniline blue, methyl violet, crystal violet, ethyl violet, brilliant green, oralochite green oxalate, methyl green, cresol red, quinaldine red, para methyl red, metanil yellow, orange IV, phenylazoaniline, erythrosin B, benzopurpurin, congo red, methyl orange, bromocresol green, resazurin, alizarin red, bromocresol purple, chlorophenol red, bromophenol blue, carbazolyl methane, bisindophthalide, fluoran, 4-(pyrrolidino) azobenzene, methylene blue, calecin, nitro blue tetrazolium salt, victoria blue B carbinol, auramine carbinol, p-phenylazophenol, 4-phenylazodiphenylamine, 4-phenylazo-1-naphthylamine, 4-phenylazoresorcinol, 3-methyl-4-phenylazophenol, p-phenylazophenyl isocyanatc, 4-(p-phenylazophenyl) semicarbazide, Rhodamine 6G, quinaldine red, b enzophenylsafranine, Bismarck brown, Sudan orange, safranine O, and the like.

In one non-limiting embodiment, the second layer is a continuous film or discontinuous coating of at least one polymer on the first layer.

In one non-limiting embodiment, the polymer which is a component of the second layer according to the claimed and/or disclosed inventive concept(s) is selected from the group consisting of carbohydrates, polysaccharides, cellulosics, cellulose esters, cellulose ethers, cellulose acetate, carboxymethyl cellulose, methyl cellulose, hydroxyethyl cellulose, hydroxypropyl cellulose, ethyl cellulose, polyethers, polyesters, polyamides, polyethylene terephthalates, polyolefins, polyurethanes, polycarbonates, polycarbamates, polylactides, polyglycolides, copolymers of lactides and glycolides, polymers derived from vinylic monomers, polymers derived from (meth)acrylic monomers, polyvinyl alcohols, polyvinyl acetates, polyvinyl butyrals, and combinations thereof.

Non-limiting, yet particular examples of polyolefins include polyethylene (PE), low-density polyethylene (LDPE), linear low-density polyethylene (LLDPE), very low-density polyethylene (VLDPE), ultra-low-density polyethylene (ULDPE), medium-density polyethylene (MDPE), high-density polyethylene (HDPE), ultra-high-density polyethylene (UHDPE), ethylene/butene-1 copolymers, ethylene/hexene-1 copolymers, ethylene/octene-1 copolymers, cyclic olefin copolymers (COC), ethylene/propylene copolymers (PEP), polypropylene (PP), propylene/ethylene copolymer (PPE), polyisoprene, polybutylene (PB), polybutene-1, poly-3-methylbutene-1, poly-4-methylpentene-1, ionomers (IO), and propylene/α-olefins (P/AO).

Non-limiting, yet particular examples of polyesters include polyethylene terephthalate (PET), amorphous polyethylene terephthalate (APET), crystalline polyethylene terephthalate (CPET), glycol-modified polyethylene terephthalate (PETG), polybutylene terephthalate, polyethylene terephthalate/isophthalate copolymer, polylactic acid (PLA), polyglycolic acid (PGA), polylactic acid-co-glycolic acid (PLGA), polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), and poly(6-hydroxydodecanoate) (PH6D).

Non-limiting, yet particular examples of polyamides include nylon 6 (polycaprolactam), nylon 11 (polyundecanolactam), nylon 12 (polylauryllactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 8,8 (polyoctamethylene suberamide), nylon 9,9 (polynonamethylene azelamide), nylon 10,9 (polydecamethylene azelamide), nylon 12,12 (polydodecamethylene dodecanediamide), nylon 6,6/6 copolymer (polyhexamethylene adipamide/caprolactam copolymer), nylon 6/6,6 copolymer (polycaprolactam/hexamethylene adipamide copolymer), nylon 6,2/6,2 copolymer (polyhexamethylene ethylenediamide/hexamethylene ethylenediamide copolymer), and nylon 6,6/6,9/6 copolymer (polyhexamethylene adipamide/hexamethylene azelaiamide/caprolactam copolymer).

Non-limiting, yet particular examples of polysaccharides include cellulose, cellulose acetate, carboxymethyl cellulose, carboxymethyl hydroxyethyl cellulose, cellulose acetate propionate carboxylate, hydroxyethyl ethyl cellulose, hydroxypropyl cellulose, hydroxypropyl methylcellulose, methyl hydroxyethyl cellulose, microcrystalline cellulose, sodium cellulose sulfate, methyl cellulose, ethyl cellulose, alkyl celluloses, hydroxyalkyl celluloses, cationic celluloses, starches, modified starches, carboxymethyl starch, hydroxyethyl starch, hydroxypropyl starch, epichlorohydrin crosslinked hydroxypropyl starch, amylopectin, modified amylopectin, amylose, modified amylose, galactomannans, modified galactomannans, guar gum, xanthan gum, gellan gum, welan gum, hydroxypropyl guar, carboxymethyl hydroxypropyl guar, locust bean gum, ghatti gum, karaya gum, tamarind gum, carrageenan, alginates, glycosaminoglycans, hyaluronic acid, and derivatives of hyaluronic acid. Further non-limiting, yet particular examples of cellulose polymers can be found in the book chapter Cellulose-Based Polymers for Packaging Applications by Tajeddin (2014), In Lignocellulosic Polymer Composites, V. K. Thakur (Ed.), Scrivener Publishing, the contents of which are herein incorporated by reference in entirety.

Non-limiting, yet particular examples of polymers derived from (meth)acrylic monomers include homopolymers, copolymers, terpolymers, and higher order polymers derived from acrylic acid, methacrylic acid, itaconic acid, β-carboxyethyl acrylate, hydroxyethyl acrylate, hydroxypropyl acrylate, hydroxyethyl methacrylate, hydroxypropyl methacrylate, methyl acrylate, butyl acrylate, amyl acrylate, hexyl acrylate, 2-ethylhexyl acrylate, octyl acrylate, isooctyl acrylate, decyl acrylate, and dodecyl acrylates.

In one non-limiting embodiment, the continuous film or discontinuous coating of the second layer according to the claimed and/or disclosed inventive concept(s) is obtained by a lamination process. In another non-limiting embodiment, the continuous film or discontinuous coating of the second layer is obtained by a printing process. In yet another non-limiting embodiment, the continuous film or discontinuous coating of the second layer is obtained by a coating process.

Details of printing processes that provide discontinuous coatings on the surface of a substrate can be obtained from the Handbook of Print Media: Technologies and Production Methods (2001), Ed. Helmut Kipphan, Springer Science & Business Media, that is herein incorporated in its entirety by reference. Details of coating processes that for provide continuous coatings on the surface of a substrate can be obtained from Modern Coating and Drying Technology (1992), Eds. E. D. Cohen and E. B. Gutoff, Wiley, that is herein incorporated in its entirety by reference.

In one non-limiting embodiment, the radiation according to the claimed and/or disclosed inventive concept(s) comprises ionizing radiation or electromagnetic radiation. In one non-limiting embodiment, the ionizing radiation comprises alpha rays, beta rays, or neutron rays. In one non-limiting embodiment, the electromagnetic radiation comprises X-rays, gamma rays, ultraviolet radiation, infrared radiation, or visible radiation.

In one non-limiting embodiment, the protective layer comprises a continuous film or discontinuous coating of at least one polymer on the second layer. In one non-limiting embodiment, the continuous film or discontinuous coating of the protective layer is obtained by a process selected from the group consisting of lamination, coating, printing, and combinations thereof.

In one non-limiting embodiment, the Net Red Optical Density of the radiation sensitive film according to the claimed or disclosed inventive concept(s) is boosted by at least ten percent compared to that of an analogous film in which the at least one second layer is colored and not optically transparent. In one non-limiting embodiment, the Net Red Optical Density of the radiation sensitive film is boosted by at least 15 percent compared to that of an analogous film in which the at least one second layer is colored and not optically transparent. In another non-limiting embodiment, the Net Red Optical Density of the radiation sensitive film is boosted by at least 20 percent compared to that of an analogous film in which the at least one second layer is colored and not optically transparent.

In a second aspect, the disclosed and/or claimed inventive concept(s) provides a process for preparing a radiation sensitive film comprising: (a) selecting at least one first layer in the form of a film of a radiation sensitive composition capable of changing opacity in response to exposure to a radiation dosage exceeding a predetermined threshold; (b) coating on top or bottom of the first layer, at least one uncolored and optically transparent second layer; and (c) optionally providing a protective layer on top of the second layer.

In a third aspect, the disclosed and/or claimed inventive concept(s) provides a process for preparing a radiation sensitive film comprising: (a) selecting at least one first layer in the form of a film of a radiation sensitive composition capable of changing opacity in response to exposure to a radiation dosage exceeding a predetermined threshold; (b) printing on top or bottom of the first layer, at least one uncolored and optically transparent second layer; and (c) optionally providing a protective layer on top of the second layer.

In a fourth aspect, the disclosed and/or claimed inventive concept(s) provides a process for preparing a radiation sensitive film comprising: (a) selecting at least one first layer in the form of a film of a radiation sensitive composition capable of changing opacity in response to exposure to a radiation dosage exceeding a predetermined threshold; (b) laminating on top or bottom of the first layer, at least one uncolored and optically transparent second layer; and (c) optionally providing a protective layer on top of the second layer.

In a fifth aspect, the disclosed and/or claimed inventive concept(s) provides a multilayer radiation dosage indicator comprising (a) a base substrate comprising a visible mark; (b) on top of the base substrate, at least one first layer comprising a radiation sensitive composition capable of changing opacity in response to exposure to a radiation dosage exceeding a predetermined threshold; (c) on top or bottom of the first layer, at least one uncolored and optically transparent second layer comprising a viewing zone through which the visible mark on the base substrate is viewable depending on opacity of the first layer prior to exposure to the radiation; and (d) optionally, a protective layer on top of the second layer.

In one non-limiting embodiment, the radiation dosage indicator according to the claimed and/or inventive concept(s) is a semi-quantitative indicator comprising a first radiation sensitive film and a second radiation sensitive film wherein the first and the second radiation sensitive films exhibit different changes in opacity in response to exposure to the radiation dosage.

In one non-limiting embodiment, the base substrate is selected from the group consisting of paper, polymer, plastic, textile, metal, canvas, cloth, wood, leather, ceramic, glass, and combinations thereof. In one non-limiting embodiment, the paper is selected from the group consisting of plain paper, coated paper, treated paper, photographic quality paper, and combinations thereof. In one non-limiting embodiment, the plastic is selected from the group consisting of vinyls, polyurethanes, polycarbonates, polyethers, polyesters, polyvinyl chloride, polystyrene, polyethylene, polyolefins, polyvinyl acetate, silicone rubbers, rubbers, polyester-polyether copolymers, ethylene methacrylate, silicones, nylon, polyamides, and combinations thereof.

In one non-limiting embodiment, the base substrate is a polymer selected from the group consisting of carbohydrates, polysaccharides, polyethers, polyesters, polyethylene terephthalates, polyolefins, polyurethanes, polycarbonates, polycarbamates, polylactides, polyglycolides, copolymers of lactides and glycolides, polymers derived from vinylic monomers, polymers derived from (meth)acrylic monomers, polyvinyl alcohols, polyvinyl acetates, and combinations thereof.

A general process for preparing multilayer radiation dosage indicators is described in the U.S. Pat. No. 5,051,597, the disclosure of which is herein incorporated by reference in its entirety.

In one non-limiting embodiment, the radiation sensitive films according to the claimed and/or disclosed inventive concept(s) are used for detection and/or measurement of radiation such as X-rays in dental, non-destructive testing, oncological, radiological or radiotherapeutic applications.

Non-limiting examples of oncological, radiological or radiotherapeutic applications include radiation therapy, surgery, chemotherapy, immunotherapy, and hormonal therapy. Non-limiting examples of cancers curable with radiation therapy either alone or in combination with other modalities include skin cancer, prostate carcinomas, lung carcinomas, cervix carcinomas, lymphomas (Hodgkin's and low grade Non-Hodgkin's), head and neck carcinomas, breast carcinomas, rectal and anal carcinomas, local advanced cervix carcinomas, bladder carcinomas, endometrial carcinomas, CNS tumors, soft tissue sarcomas, and pediatric tumors. More information on cancer and radiation therapy and its current advances and future directions can be found in Baskar et al., Int J Med Sci, 2012 (9), 193-199 that is herein incorporated in its entirety by reference. Monitoring of the oral cavity and dental health is required during radiation therapy, particularly of the head and neck, to decrease the severity of the side effects.

In one non-limiting embodiment, the method of measurement and/or detection of radiation such as X-rays using the radiation sensitive films according to the claimed and/or disclosed inventive concept(s) is non-destructive in nature. In general, in the fields of radiology and radiography, non-destructive detection, testing and/or measuring methods are those that help to maintain the integrity and properties of materials or components that are exposed to radiation without causing undue damage to the tested object.

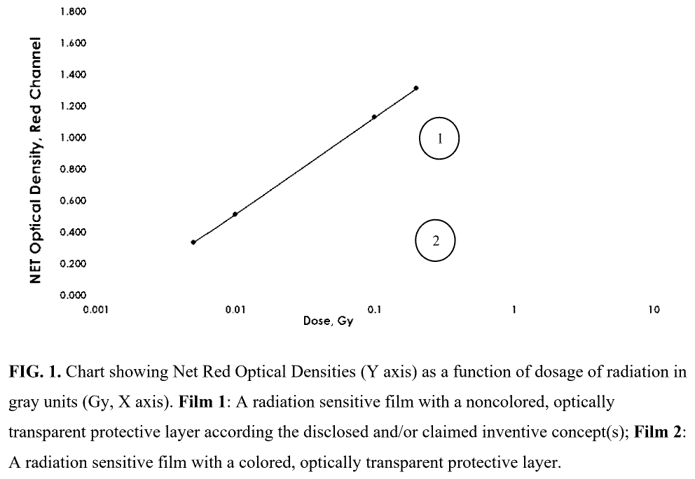

FIG. 1 is a chart of Net Red Optical Densities of different films including the radiation sensitive films according the disclosed and/or claimed inventive concept(s) (Y axis) as a function of radiation dosage in gray units (Gy, X axis). As seen in FIG. 1, the exemplary radiation sensitive film according the disclosed and/or claimed inventive concept(s) (Film 1) exhibits significantly higher Net Red Optical Density values compared to a radiation sensitive film (Film 2) having a colored, optically transparent protective layer and optionally having an intensifying screen like lead metal. This comparative study demonstrates the improved radiation sensitives of the radiation sensitive films according the disclosed and/or claimed inventive concept(s).

What we claim is:

1. A radiation sensitive film comprising:
(a) at least one first layer comprising a radiation sensitive composition capable of changing opacity in response to exposure to a radiation dosage exceeding a predetermined threshold;
(b) on top or bottom of said first layer, at least one uncolored and optically transparent second layer; and
(c) optionally, a protective layer on top of said second layer.

2. The radiation sensitive film according to claim 1 wherein said first layer is white.

3. The radiation sensitive film according to claim 1 wherein said first layer is not colored.

4. The radiation sensitive film according to claim 1 wherein the bottom surface of said second layer comprises an uncolored and optically transparent adhesive layer for attaching said first layer to said second layer.

5. The radiation sensitive film according to claim 1 wherein said radiation sensitive composition comprises at least one acetylenic compound.

6. The radiation sensitive film according to claim 5 wherein said acetylenic compound comprises at least one acetylene moiety and at least one non-acetylenic functional group.

7. The radiation sensitive film according to claim 6 wherein said non-acetylenic functional group is selected from the group consisting of carboxyl, carboxylate, hydroxy, hydroxide, alkoxy, alkoxide, epoxy, amino, ammonium, aldehyde, keto, amide, ester, nitrile, urethane, ether, and combinations thereof.

8. The radiation sensitive film according to claim 7 wherein said non-acetylenic functional group is selected from the group consisting of carboxyl, carboxylate, and combinations thereof.

9. The radiation sensitive film according to claim 5 wherein said acetylenic compound is selected from the group consisting of decadiynoic acids, undecadiynoic acids, dodecadiynoic acids, tridecadiynoic acids, tetradecadiynoic acids, pentadecadiynoic acids, hexadecadiynoic acids, heptadecadiynoic acids, octadecadiynoic acids, nonadecadiynoic acids, icosadiynoic acids, heneicosadiynoic acids, docosadiynoic acids, tricosadiynoic acids, tetracosadiynoic acids, pentacosadiynoic acids, hexacosadiynoic acids, heptacosadiynoic acids, octacosadiynoic acids, nonacosadiynoic acids, triacontanediynoic acids, salts thereof, and combinations thereof.

10. The radiation sensitive film according to claim 9 wherein said acetylenic compound is selected from the group consisting of 10,12-pentacosadiynoic acid, a salt thereof, and combinations thereof.

11. The radiation sensitive film according to claim 1 wherein said radiation sensitive composition comprises at least one radiation sensitive dye.

12. The radiation sensitive film according to claim 1 wherein said second layer is a continuous film or discontinuous coating of at least one polymer on said first layer.

13. The radiation sensitive film according to claim 12 wherein said polymer is selected from the group consisting of carbohydrates, polysaccharides, cellulosics, cellulose esters, cellulose ethers, cellulose acetate, carboxymethyl cellulose, methyl cellulose, hydroxyethyl cellulose, hydroxypropyl cellulose, ethyl cellulose, polyethers, polyesters, polyamides, polyethylene terephthalates, polyolefins, polyurethanes, polycarbonates, polycarbamates, polylactides, polyglycolides, copolymers of lactides and glycolides, polymers derived from vinylic monomers, polymers derived from (meth)acrylic monomers, polyvinyl alcohols, polyvinyl acetates, polyvinyl butyrals, and combinations thereof.

14. The radiation sensitive film according to claim 12 wherein said continuous film or discontinuous coating is obtained by a lamination process.

15. The radiation sensitive film according to claim 12 wherein said continuous film or discontinuous coating is obtained by a coating process.

16. The radiation sensitive film according to claim 12 wherein said continuous film or discontinuous coating is obtained by a printing process.

17. The radiation sensitive film according to claim 1 wherein said radiation comprises ionizing radiation or electromagnetic radiation.

18. The radiation sensitive film according to claim 17 wherein said ionizing radiation comprises alpha rays, beta rays, or neutron rays.

19. The radiation sensitive film according to claim 17 wherein said electromagnetic radiation comprises X-rays, gamma rays, ultraviolet radiation, infrared radiation, or visible radiation.

20. The radiation sensitive film according to claim 1 wherein said protective layer comprises a continuous film or discontinuous coating of at least one polymer on said second layer.

21. The radiation sensitive film according to claim 20 wherein said continuous film or discontinuous coating is obtained by a process selected from the group consisting of lamination, coating, printing, and combinations thereof.

22. The radiation sensitive film according to claim 1 wherein the net Red Optical Density of said film is boosted by at least ten percent compared to that of an analogous film wherein said at least one second layer is colored.

23. A process for preparing a radiation sensitive film comprising: (a) selecting at least one first layer in the form of a film of a radiation sensitive composition capable of changing opacity in response to exposure to a radiation dosage exceeding a predetermined threshold; (b) coating on top or bottom of said first layer, at least one uncolored and optically transparent second layer; and (c) optionally providing a protective layer on top of said second layer.

24. A process for preparing a radiation sensitive film comprising: (a) selecting at least one first layer in the form of a film of a radiation sensitive composition capable of changing opacity in response to exposure to a radiation dosage exceeding a predetermined threshold; (b) printing on top or bottom of said first layer, at least one uncolored and optically transparent second layer; and (c) optionally providing a protective layer on top of said second layer.

25. A process for preparing a radiation sensitive film comprising: (a) selecting at least one first layer in the form of a film of a radiation sensitive composition capable of changing opacity in response to exposure to a radiation dosage exceeding a predetermined threshold; (b) laminating on top or bottom of said first layer, at least one uncolored and optically transparent second layer; and (c) optionally providing a protective layer on top of said second layer.

26. A multilayer radiation dosage indicator comprising:
(a) a base substrate comprising a visible mark;
(b) on top of said base substrate, at least one first layer comprising a radiation sensitive composition capable of changing opacity in response to exposure to a radiation dosage exceeding a predetermined threshold;
(c) on top or bottom of said first layer, at least one uncolored and optically transparent second layer comprising a viewing zone through which said visible mark on said base substrate is viewable depending on opacity of said first layer prior to exposure to said radiation; and
(d) optionally, a protective layer on top of said second layer.

27. The radiation dosage indicator of claim 26 wherein said indicator is a semi-quantitative indicator comprising a first radiation sensitive film and a second radiation sensitive film wherein said first and said second radiation sensitive films exhibit different changes in opacity in response to exposure to said radiation dosage.
